(19) United States
(12) Patent Application Publication
(10) Pub. No.: US 2013/0227449 A1
(43) Pub. Date: Aug. 29, 2013

(54) Multi-dimensional User Interface

(71) Applicant: Thomas A. Brown, West Chester, PA (US)

(72) Inventor: Thomas A. Brown, West Chester, PA (US)

(73) Assignee: COMCAST CABLE COMMUNICATIONS, LLC, Philadelphia, PA (US)

(21) Appl. No.: 13/408,261

(22) Filed: Feb. 29, 2012

(51) Int. Cl. G06F 3/048

(52) U.S. Cl. 715/764

(57) ABSTRACT

Systems and methods for providing a user interface are disclosed. One method comprises classifying each of a plurality of data or devices based upon one or more of a plurality of genera and a plurality of species, wherein each of the plurality of species is subordinate to one or more of the genera, associating each of a plurality of first portions of an image with one of the plurality of genera, and associating each of a plurality of second portions of the image with one of the plurality of genera and one of the plurality of species.

### BACKGROUND

Interfacing with a plurality of data resources such as files, statistics, webpages and/or devices, for example, can become cumbersome as the number of resources and classification/perspective of such resources increases. Typically, a series of drop-down menus can be used to identify classifications and sub-classification of data such as files. However, drop-down menus require a substantial portion of the viewable area of a user interface in order to provide a representation of the selectable menus options available to a user. Further, drop-down menus typically require successive selections for each classification or sub-classification in order expose further selectable menus items or options of the user. What is needed is a user interface for efficiently selecting one or more options and/or interacting with one or more resources.

### SUMMARY

It is to be understood that both the following general description and the following detailed description are exemplary and explanatory only and are not restrictive, as claimed. Provided are methods and systems for interfacing with a user. In an aspect, a user interface can be configured to provide a multi-dimensional navigation tool for interacting with and/or controlling one or more resources.

In an aspect, a method for interfacing with a user can comprise classifying each of a plurality of types of data, or devices, based upon one or more of a plurality of genera and a plurality of species relating to characteristics of a respective one of the plurality of devices (or data), wherein each of the plurality of species is subordinate to one or more of the genera. Each of a plurality of first portions of an interface (e.g., image) can be associated with one of the plurality of genera and each of a plurality of second portions of the image can be associated with one of the plurality of genera and one of the plurality of species. A feedback can be rendered in response to a selection of the second portion, wherein the feedback is based upon a relationship between the selected second portion and an associated genus and species.

In another aspect, a method for interfacing with a user can comprise classifying each of a plurality of devices based upon one or more of a plurality of genera and a plurality of species relating to characteristics of a respective one of the plurality of types of data, or devices, wherein each of the plurality of species (or data) is subordinate to one or more of the genera. Each of a plurality of first portions of an image can be associated with one of the plurality of genera and each of a plurality of second portions of the image can be associated with one of the plurality of genera and one of the plurality of species. Information can be retrieved relating to each of the plurality of devices (or data) associated with a selected one of the plurality of second portions.

In yet another aspect, a method for interfacing with a user can comprise classifying each of a plurality of user options based upon one or more of a plurality of genera and a plurality of species relating to preferences of a user, wherein each of the plurality of species is subordinate to one or more of the genera. Each of a plurality of first portions of an interface (e.g., image) can be associated with one of the plurality of genera and each of a plurality of second portions of the image can be associated with one of the plurality of genera and one of the plurality of species. An information can be retrieved relating to each of the plurality of user options associated with a selected one of the plurality of second portions.

In yet another aspect, a method for interfacing with a user can comprise classifying each of a plurality of devices based upon one or more of a plurality of genera and a plurality of species relating to characteristics of a respective one of the plurality of devices, wherein each of the plurality of species is subordinate to one or more of the genera. Each of a plurality of first portions of an image can be associated with one of the plurality of genera and each of a plurality of second portions of the image can be associated with one of the plurality of genera and one of the plurality of species. In response to a selection of one of the second portions, a signal can be transmitted to each of the plurality of devices associated with the selected one of the plurality second portions.

Additional advantages will be set forth in part in the description which follows or may be learned by practice. The advantages will be realized and attained by means of the elements and combinations particularly pointed out in the appended claims. It is to be understood that both the foregoing general description and the following detailed description are exemplary and explanatory only and are not restrictive, as claimed.

### BRIEF DESCRIPTION OF THE DRAWINGS

The accompanying drawings, which are incorporated in and constitute a part of this specification, illustrate embodiments and together with the description, serve to explain the principles of the methods and systems:

FIG. 1A is a block diagram of an exemplary network;

FIG. 1B is a representation of an exemplary user interface;

FIG. 2 is a block diagram of an exemplary computing device;

FIG. 3 is a flow chart of an exemplary method;

FIG. 4 is a flow chart of an exemplary method;

FIG. 5 is a flow chart of an exemplary method; and

FIG. 6 is a flow chart of an exemplary method.

### DETAILED DESCRIPTION

Before the present methods and systems are disclosed and described, it is to be understood that the methods and systems are not limited to specific methods, specific components, or to particular implementations. It is also to be understood that the terminology used herein is for the purpose of describing particular embodiments only and is not intended to be limiting.

As used in the specification and the appended claims, the singular forms “a,” “an” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific embodiment or combination of embodiments of the disclosed methods.

The present methods and systems may be understood more readily by reference to the following detailed description of preferred embodiments and the examples included therein and to the Figures and their previous and following description.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, or magnetic storage devices.

Embodiments of the methods and systems are described below with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, can be implemented by computer program instructions. These computer program instructions may be loaded onto a general purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

As described in greater detail below, a system can be configured to distinguish a classification of resources. A user interface can be configured to provide a multi-dimensional navigation tool for interacting with and/or controlling one or more resources.

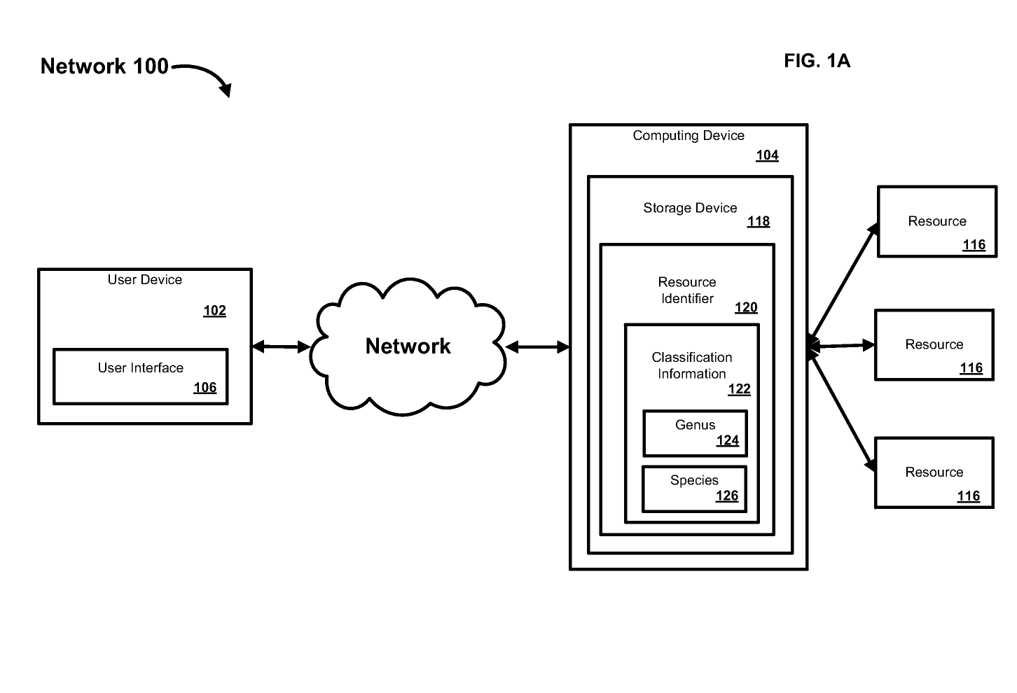

FIG. 1 illustrates various aspects of an exemplary system in which the present methods and systems can operate. The present disclosure relates to systems and methods for interfacing with a user. Those skilled in the art will appreciate that present methods may be used in systems that employ both digital and analog equipment. One skilled in the art will appreciate that provided herein is a functional description and that the respective functions can be performed by software, hardware, or a combination of software and hardware.

The network 100 can comprise a user device 102 in communication with a computing device 104 such as a server, for example. The computing device 104 can be disposed locally or remotely relative to the user device 102. As an example, the user device 102 and the computing device 104 can be in communication via a network such as the Internet. However, other forms of communications, now known, can be used such as wired and wireless telecommunication channels, for example.

In an aspect, the user device 102 can be an electronic device such as a computer, a smartphone, a laptop, a tablet, a set top box, or other device capable of communicating with the computing device 104. In an aspect, the user device 102 can be configured to consume various media types. As an example, the user device 102 can comprise a user interface 106 for allowing a user to interact with the user device 102 and/or the computing device 104. As a further example, the user interface 106 can be rendered as at least a portion of a web browser such as Internet Explorer, Mozilla Firefox, Google Chrome, Safari, or the like. Other software, hardware, and/or interfaces can be used to provide communication between the user and one or more of the user device 102 and the computing device 104. As an example, the web browser can request or query various files from a local source and/or a remote source.

In an aspect, the user interface 106 can comprise a graphical user interface. As an example, the user interface 106 can be provided as a portal to a network, a window in a browser program, or provided as an interface for any other application. As a further example, the user interface 106 can be navigable by a user operating the user device 102.

In an aspect, the user interface 106 can comprise an image 108 defining a plurality of user-selectable graphical objects 109, as illustrated in FIG. 1B. In an aspect, each of the plurality of graphical regions or objects 109 can be configured to provide a link or connection to one or more data objects stored in a storage device. As an example, each of the plurality of graphical objects 109 can be configured to correspond to a particular operation such as requesting/transmitting data and/or transmitting a control signal to a particular resource or device associated with the corresponding graphical object 109. The user interface 106 can comprise any image or graphic for rendering selectable options to a user.

In an aspect, the image 108 can have any size, shape, and arrangement. As an example the image 108 can comprise one or more geometric shapes such as concentric circles. In an aspect, the image 108 can comprise one or more first portions 110 and one or more second portions 112. The first portions 110 and second portions 112 can comprise any part of the image 108 or user interface 106 and can have any shape, size, and arrangement. As a further example, one or more of the second portions 112 of the image 108 can be disposed radially inward relative to one or more of the first portions 110 of the image 108. The image 108 can comprise any number of portions or division such as one or more third portions 114 (e.g., disposed radially inward relative to one or more of the first portions 110 and/or second portions 112). Other arrangements and mapping of the image 108 can be used. In an aspect, the first portions 110 and second portions 112 represent sub-divisions of the user interface 106 that is not rendered as an image, such as a physical button or other apparatus.

Returning to FIG. 1A, the computing device 104, in an aspect, can be a server for communicating with the user device 102. As an example, the computing device 104 can be in communication with one or more resources 116 such as data collections, file, webpages, end-point devices, terminals, communication devices, content consumption device, and/or other data, devices, or systems. As a further example, the computing device 104 can manage the intercommunication between the user device 102 and a storage device 118 for sending and receiving data therebetween. In an aspect, the storage device 118 can store a plurality of files (e.g. web pages and other data). As an example, the user device 102 can request/retrieve a file directly and/or indirectly from the storage device 118. In an aspect, the storage device 118 can be integrated with the computing device 104. However, the storage device 118 can be located remote from the computing device 104.

In an aspect, a plurality of resource identifiers 120 can be stored on the storage device 118 or on another storage medium. As an example, each of the resource identifier 120 can be any identifier, token, character, string, or the like, associated with one or more of the resources 116 for differentiating the one or more of the resources 116 from another of the resources 116. In an aspect, the resource identifiers 120 can be relied upon for transmitting data and/or control information to one or more of the resources 116. As an example, one or more of the resources 116 and/or resource identifiers 120 can be classified based upon a characteristics such as a date, time, resource state, location, function, use, aggregate use of a grouping of resources 116, or other distinguishing factor.

In an aspect, one or more of the resource identifiers 120 can comprise classification information 122 relating to the classification of a respective resource identifier 120. As an example, the classification information 122 can comprise a hierarchal classification structure including one or more genera 124 or broad classification category and one or more species 126 or sub-classification. As another example, each of a plurality of genera 124 can be distinct from another one of the genera 124. As a further example, each of the plurality of species 126 can be distinct from another one of the genera 124. In an aspect, one or more of the species 126 can be a subset of one or more of the genera 124, wherein the species 126 are related in context to the genera 124 under which they are arranged. Other arrangements of classifications and sub-classification can be used to classify the resources 116 and/or resource identifiers 120.

In an aspect, each of a plurality of types of data and/or devices (e.g., resources 116) can be classified based upon one or more broad classifications (e.g., genera 124) and one or more sub-classifications (e.g., species 126) relating to characteristics of a respective one of the plurality of devices. As an example each of the sub-classifications can be subordinate to one or more of the broad classifications. As a further example, the classifications of the plurality of devices can be represented by the classification information 122. In an aspect, the classifications and sub-classifications of the devices can be based upon one or more of a location, a use of the device, an aggregate use of a plurality of devices, a time, an operation or function of the device, and other classification metrics. In an aspect, any devices can be classified as described herein such as communication devices, mobile devices, content consumption devices, and other means for receiving, transmitting, and/or processing data.

In an aspect, each of a plurality of user options (e.g., resources 116) can be classified based upon one or more broad classifications (e.g., genera 124) and one or more sub-classifications (e.g., species 126) relating to characteristics of a respective one of the plurality of user options. As an example, a broad classification of user options relating to overall network usage can comprise a plurality of sub-options relating to particular devices consuming the content, particular content being consumed, and/or time of data transfer. As a further example, a broad classification of user options relating to content genre can comprise sub-options or classification relating to particular actors, directors, content playback time, content rating, and the like. In an aspect, the user options can be based upon a service provided to the user such as a network service, a content service, or a communication service, for example. Other services and options can be used. As an example, each of the sub-classifications of user-options can be subordinate to one or more of the broad classifications. In an aspect, a genus of user options can be related to one of a plurality of services offered to the user and various species can be defined by service plans or service tiers provided under the overarching service classification. As a further example, the classifications of the plurality of user options can be represented by the classification information 122. In an aspect, the classifications and sub-classifications of the devices can be based upon one or more of a location, a use of the device, an aggregate use of a plurality of devices, a time, an operation or function of the device, and other classification metrics.

As described in greater detail below, a computing device can be configured to distinguish a classification of resources. The computing device an be configured to provide and/or interface with a multi-dimensional navigation tool for interacting with and/or controlling one or more resources.

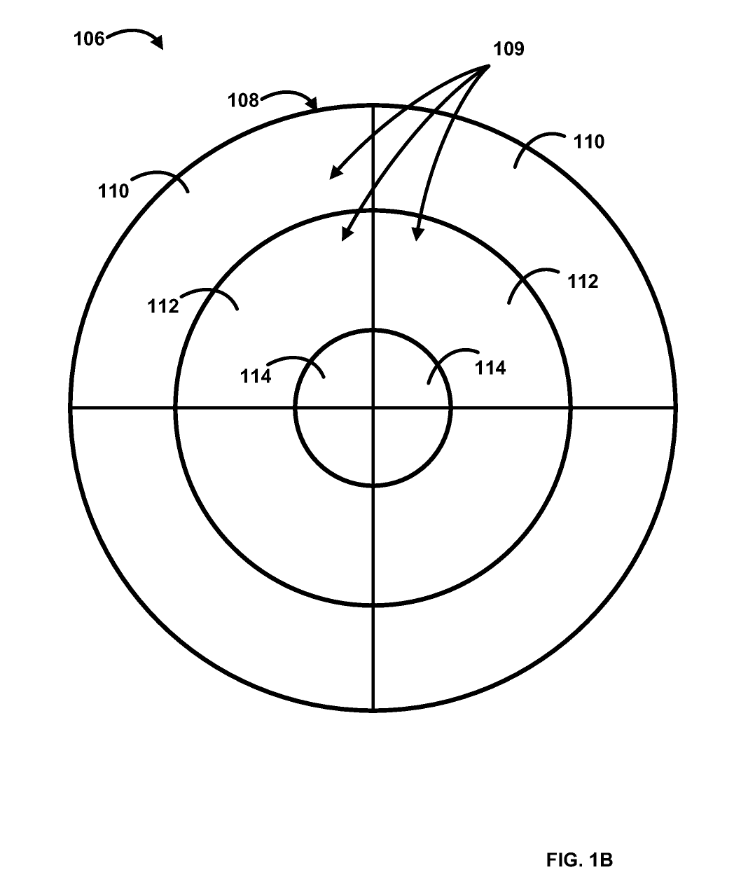

In an exemplary aspect, the methods and systems can be implemented on a computing system such as computing device 201 as illustrated in FIG. 2 and described below. By way of example, one or more of the user device 102 and the computing device 104 of FIG. 1 can be a computer as illustrated in FIG. 2. Similarly, the methods and systems disclosed can utilize one or more computers to perform one or more functions in one or more locations. FIG. 2 is a block diagram illustrating an exemplary operating environment for performing the disclosed methods. This exemplary operating environment is only an example of an operating environment and is not intended to suggest any limitation as to the scope of use or functionality of operating environment architecture. Neither should the operating environment be interpreted as having any dependency or requirement relating to any one or combination of components illustrated in the exemplary operating environment.

The present methods and systems can be operational with numerous other general purpose or special purpose computing system environments or configurations. Examples of well known computing systems, environments, and/or configurations that can be suitable for use with the systems and methods comprise, but are not limited to, personal computers, server computers, laptop devices, and multiprocessor systems. Additional examples comprise set top boxes, programmable consumer electronics, network PCs, minicomputers, mainframe computers, distributed computing environments that comprise any of the above systems or devices, and the like.

The processing of the disclosed methods and systems can be performed by software components. The disclosed systems and methods can be described in the general context of computer-executable instructions, such as program modules, being executed by one or more computers or other devices. Generally, program modules comprise computer code, routines, programs, objects, components, data structures, etc. that perform particular tasks or implement particular abstract data types. The disclosed methods can also be practiced in grid-based and distributed computing environments where tasks are performed by remote processing devices that are linked through a communications network. In a distributed computing environment, program modules can be located in both local and remote computer storage media including memory storage devices.

Further, one skilled in the art will appreciate that the systems and methods disclosed herein can be implemented via a general-purpose computing device in the form of a computing device 201. The components of the computing device 201 can comprise, but are not limited to, one or more processors or processing units 203, a system memory 212, and a system bus 213 that couples various system components including the processor 203 to the system memory 212. In the case of multiple processing units 203, the system can utilize parallel computing.

The system bus 213 represents one or more of several possible types of bus structures, including a memory bus or memory controller, a peripheral bus, an accelerated graphics port, and a processor or local bus using any of a variety of bus architectures. By way of example, such architectures can comprise an Industry Standard Architecture (ISA) bus, a Micro Channel Architecture (MCA) bus, an Enhanced ISA (EISA) bus, a Video Electronics Standards Association (VESA) local bus, an Accelerated Graphics Port (AGP) bus, and a Peripheral Component Interconnects (PCI), a PCI-Express bus, a Personal Computer Memory Card Industry Association (PCMCIA), Universal Serial Bus (USB) and the like. The bus 213, and all buses specified in this description can also be implemented over a wired or wireless network connection and each of the subsystems, including the processor 203, a mass storage device 204, an operating system 205, classification software 206, classification data 207, a network adapter 208, system memory 212, an Input/Output Interface 210, a display adapter 209, a display device 211, and a human machine interface 202, can be contained within one or more remote computing devices 214a,b,c at physically separate locations, connected through buses of this form, in effect implementing a fully distributed system.

The computing device 201 typically comprises a variety of computer readable media. Exemplary readable media can be any available media that is accessible by the computing device 201 and comprises, for example and not meant to be limiting, both volatile and non-volatile media, removable and non-removable media. The system memory 212 comprises computer readable media in the form of volatile memory, such as random access memory (RAM), and/or non-volatile memory, such as read only memory (ROM). The system memory 212 typically contains data such as classification data 207 and/or program modules such as operating system 205 and classification software 206 that are immediately accessible to and/or are presently operated on by the processing unit 203.

In another aspect, the computing device 201 can also comprise other removable/non-removable, volatile/non-volatile computer storage media. By way of example, FIG. 2 illustrates a mass storage device 204 which can provide non-volatile storage of computer code, computer readable instructions, data structures, program modules, and other data for the computing device 201. For example and not meant to be limiting, a mass storage device 204 can be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Optionally, any number of program modules can be stored on the mass storage device 204, including by way of example, an operating system 205 and classification software 206. Each of the operating system 205 and classification software 206 (or some combination thereof) can comprise elements of the programming and the classification software 206. Classification data 207 can also be stored on the mass storage device 204. Classification data 207 can be stored in any of one or more databases known in the art. Examples of such databases comprise, DB2®, Microsoft® Access, Microsoft® SQL Server, Oracle®, mySQL, PostgreSQL, and the like. The databases can be centralized or distributed across multiple systems.

In another aspect, the user can enter commands and information into the computing device 201 via an input device (not shown). Examples of such input devices comprise, but are not limited to, a keyboard, pointing device (e.g., a “mouse”), a microphone, a joystick, a scanner, tactile input devices such as gloves, and other body coverings, and the like These and other input devices can be connected to the processing unit 203 via a human machine interface 202 that is coupled to the system bus 213, but can be connected by other interface and bus structures, such as a parallel port, game port, an IEEE 1394 Port (also known as a Firewire port), a serial port, or a universal serial bus (USB).

In yet another aspect, a display device 211 can also be connected to the system bus 213 via an interface, such as a display adapter 209. It is contemplated that the computing device 201 can have more than one display adapter 209 and the computing device 201 can have more than one display device 211. For example, a display device can be a monitor, an LCD (Liquid Crystal Display), or a projector. In addition to the display device 211, other output peripheral devices can comprise components such as speakers (not shown) and a printer (not shown) which can be connected to the computing device 201 via Input/Output Interface 210. Any step and/or result of the methods can be output in any form to an output device. Such output can be any form of visual representation, including, but not limited to, textual, graphical, animation, audio, tactile, and the like. The display 211 and computing device 201 can be part of one device, or separate devices.

The computing system 201 can operate in a networked environment using logical connections to one or more remote computing devices 214a,b,c. By way of example, a remote computing device can be a personal computer, portable computer, a smart phone, a server, a router, a network computer, a peer device or other common network node, and so on. Logical connections between the computing device 201 and a remote computing device 214a,b,c can be made via a network 215, such as a local area network (LAN) and a general wide area network (WAN). Such network connections can be through a network adapter 208. A network adapter 208 can be implemented in both wired and wireless environments. Such networking environments are conventional and commonplace in dwellings, offices, enterprise-wide computer networks, intranets, and the Internet.

For purposes of illustration, application programs and other executable program components such as the operating system 205 are illustrated herein as discrete blocks, although it is recognized that such programs and components reside at various times in different storage components of the computing device 201, and are executed by the data processor(s) of the computer. An implementation of classification software 206 can be stored on or transmitted across some form of computer readable media. Any of the disclosed methods can be performed by computer readable instructions embodied on computer readable media. Computer readable media can be any available media that can be accessed by a computer. By way of example and not meant to be limiting, computer readable media can comprise “computer storage media” and “communications media.” “Computer storage media” comprise volatile and non-volatile, removable and non-removable media implemented in any methods or technology for storage of information such as computer readable instructions, data structures, program modules, or other data. Exemplary computer storage media comprises, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

The methods and systems can employ Artificial Intelligence techniques such as machine learning and iterative learning. Examples of such techniques include, but are not limited to, expert systems, case based reasoning, Bayesian networks, behavior based AI, neural networks, fuzzy systems, evolutionary computation (e.g. genetic algorithms), swarm intelligence (e.g. ant algorithms), and hybrid intelligent systems (e.g. Expert inference rules generated through a neural network or production rules from statistical learning).

As described in greater detail below, provided are methods for interfacing with a user by providing a multi-dimensional navigation tool for interacting with one or more resources.

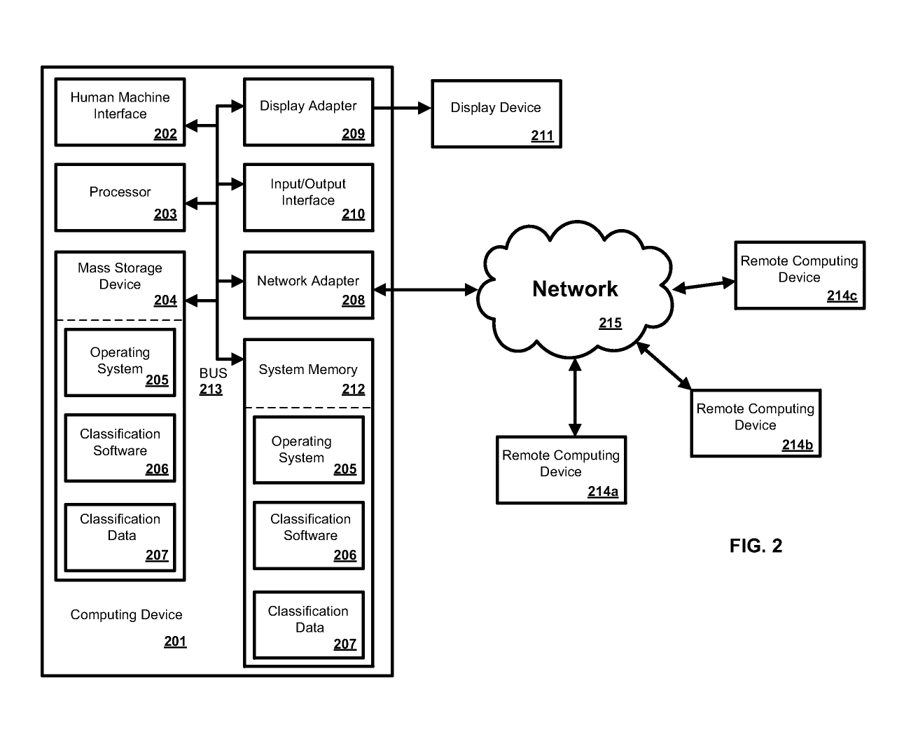

FIG. 3 illustrates an exemplary method for interfacing with a user. In an aspect, the method illustrated in FIG. 3 will be discussed in reference to FIGS. 1-2. In step 302, each of a plurality of resources 116 (e.g., devices, data, files, webpages, etc.) can be classified based upon one or more genera 124 and one or more species 126 based upon characteristics relating to a respective one of the plurality of resources 116. As an example, each of the plurality of species 126 can be subordinate to one or more of the genera 124. As a further example, the resources 116 can be classified based upon any number of characteristics relating to the resources 116.

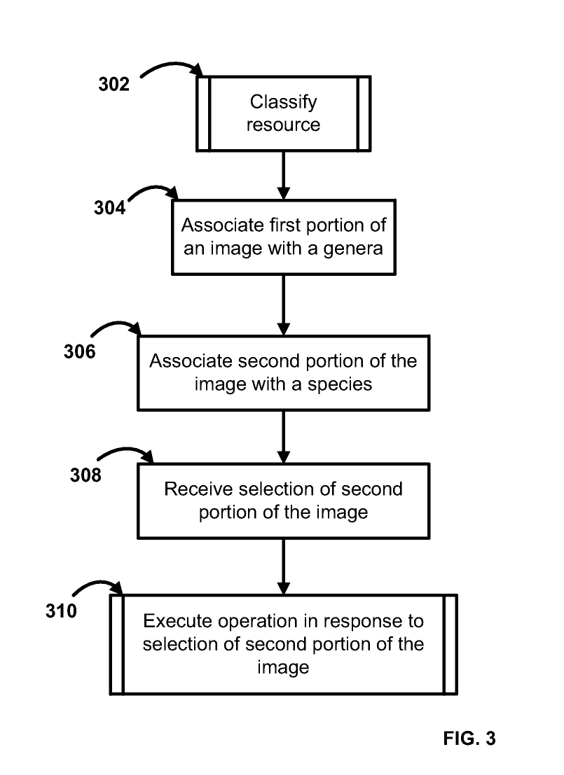

In an aspect, FIG. 4 illustrates an exemplary sub-routine for classifying one or more resources 116. The method illustrated in FIG. 4 will be discussed in reference to FIGS. 1-2. In step 402, one or more of the genera 124 can be determined for a particular one of the resources 116. For example, the one of the resources 116 can be a smartphone located in Philadelphia, Pa. Accordingly, the smartphone can be classified by a location genus of Pennsylvania. Other classifications and genera 124 can be used.

In step 404, one or more of the species 126 can be determined for a particular one of the resources 116. For example, the one of the resources 116 can be a smartphone located in Philadelphia, Pa. Accordingly, the smartphone can be classified by a location species of Philadelphia. Other classifications, sub-classifications and/or species 126 can be used.

In an aspect, the resource 116 can be classified based upon any number of genera 124 and species 126. As an example, a cable network device can be classified by a general location such as a global division with sub-classifications of region, market, site, and/or individual devices. As a further example, a communication device can be classified by an overall usage with sub-classifications of voice usage, data usage, time of day of usage, and/or usage patterns. As a further example, various user service options can be classification by a service field or service identifier (e.g., voice, television, Internet) with sub-classifications or sub-options such as data limits, content add-ons, service tiers, etc. Any option, device, resource or data can be classified by any classification, genus 124 and/or species 126 in a similar manner as described herein.

Returning to FIG. 3, in step 304, a first portion (e.g., one of the portions 110, 112, 114) of the user interface 106 can be associated with one of the genera 124 determined in step 302. As an example, a first portion of an interface, such as an image (e.g., image 108) can be mapped with one of the genera 124 determined in step 302. As a further example, information relating to the genera 124 (or resources 116 classified under the respective genera 124) that is mapped to the first portion can be linked to the first portion such that a selection of the first portion can cause the information to be retrieved, transmitted, and/or processed. In an aspect, the information that is linked to the first portion can comprise resource identifiers 120 and/or classification information 122. As such, the resource identifiers and associated classification information 122 can be processed as a representation of the associated resources 116.

In step 306, a second portion of the user interface 106 can be associated with one of the genera 124 and one of the species 126 determined in step 302. As an example, a second portion of an image (e.g., image 108) can be associated with one of the genera 124 and one of the species 126 determined in step 302. As a further example, information relating to the genera 124 and species 126 (or resources 116 classified under the respective genera 124 and species 126) that are mapped to the second portion can be linked to the second portion such that a selection of the second portion can cause the information to be retrieved, transmitted, and/or processed. In an aspect, the information that is linked to the second portion can comprise resource identifiers 120 and/or classification information 122. As such, the resource identifiers and associated classification information 122 can be processed as a representation of the associated resources 116.

In step 308, a selection of a portion of the user interface 106 can be received. Any portion of the user interface 106 can be selected. As an example, a selection of the second portion of the user interface 106 can be received. As a further example, a user can manipulate, engage, or otherwise interact with the user interface 106 in order to trigger a selection of the second portion configured in step 306. In an aspect, the user interface 106 can be rendered, at least in part, as image 108 or another image, on a user-engageable device such as a touch screen or display having a moveable and engageable cursor or icon. In this way, a user can interact with the user interface 106 to select a portion of the user interface 106. The user interface 106 can comprise hard buttons or other user-engageable keys or apparatus for receiving a selection from the user.

In step 310, a pre-defined operation can be executed in response to the selection of a portion of the user interface 106. As an example, the second portion can be selected and the pre-defined operation can be based upon a relationship between the selected second portion and the genus 124 and species 126 associated with the second portion. Typically, in a conventional system, a user can provide a broad first input and then a second input would be provided to select a sub-classification of the broad first input. Conversely, as an example, the user interface 106 allows a user to engage the second portion with a single “touch” or “click” to provide a plurality of inputs (e.g., the genus 124 and species 126 associated with the second portion). As an illustrative example, a user may wish to query the content consumption of various user devices in a given market. Using the user interface 106, the user can simply engage the portion of the user interface 106 representing the desired market (i.e. genera 124 or broad classification) and content consumption (i.e. species 126 or sub-classification). By selecting the portion of the user interface 106 representing the specific query, the user provides multiple inputs with a single operation.

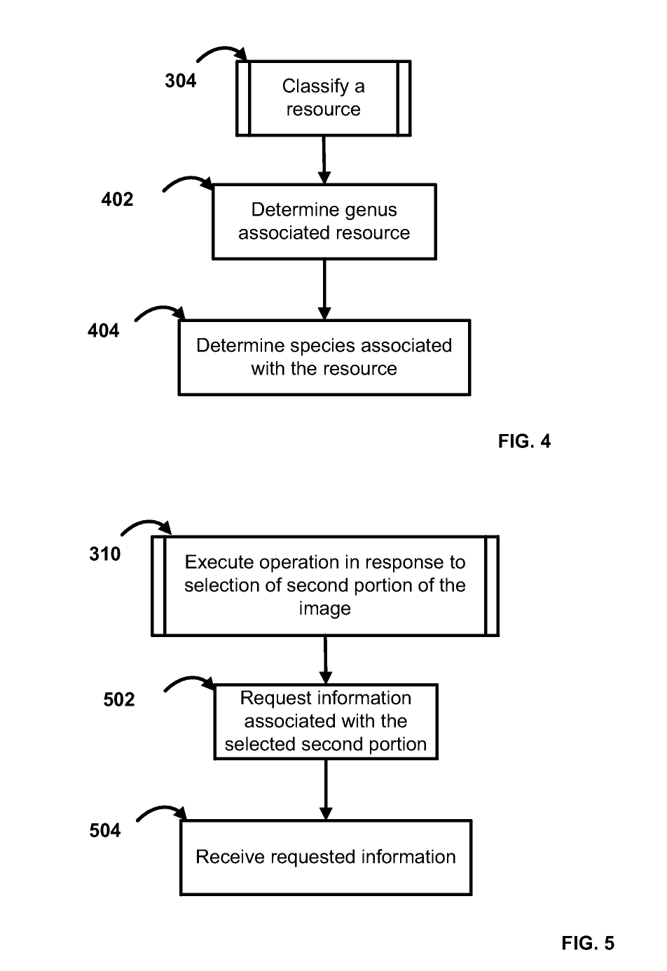

In an aspect, the pre-defined operation executed in step 310 can comprise a sub-routine, as shown in FIG. 5. In step 502, information can be requested in response to the selection of a portion of the user interface 106. As an example, the second portion can be selected and the information requested can be related to the genus 124 and species 126 associated with the second portion.

In step 504, the pre-defined operation associated with the selected second portion can comprise retrieving the requested information. As an example, if the second portion selected is associated with a classification or genus 124 representing the location classification of “East Division” and a sub-classification or species of “peak time of day”, the resultant information that is retrieved would be related to resources in the “East division” operating during the “peak time of day.” As a further example, the information retrieved can comprise, at least in part, the resource identifiers 120 and/or classification information 122 relating to the queried classifications. In an aspect, the second portion may be associated with any number of classifications. As an example, if the second portion selected is associated with a classification or genus 124 of “East Division” and a sub-classification of “peak time of day” and sub-sub-classification or species of “bandwidth usage,” the resultant information that is retrieved would be related to “bandwidth usage” of resources 116 in the “East division” operating during the “peak time of day.” In an aspect, one or more genus 124 and/or one or more species 126 can be defined and/or updated in real-time based upon information collected by the system (e.g., content based data, user-based data, device-based data). As an example, one or more genus 124 and/or one or more species 126 can be based upon classifications and/or sub classifications of information from historical events/data, from predicted future events/data, and/or from substantially real-time or instantaneous events/data.

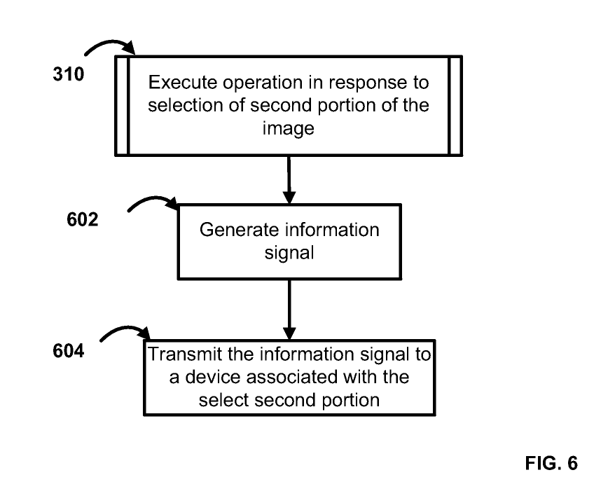

In an aspect, the pre-defined operation executed in step 310 can comprise a sub-routine, as shown in FIG. 6. In step 602, an information signal or control signal can comprise generated in response to the selection of a portion of the user interface 106. As an example, the second portion can be selected and an information signal or control signal can be generated to provide information, control, instruction or other data to a device classified under the genus 124 and species 126 associated with the second portion.

In step 604, the pre-defined operation associated with the selected second portion can comprise transmitting an information signal or control signal to a particular device classified under the genus 124 and species 126 associated with the second portion. As an example, if the second portion selected is associated with a classification or genus 124 of “East division” and a sub-classification or species 126 of “Atlantic Coast Market”, the resultant information signal or control signal can be transmitted to all devices classified in the “East division” and sub-classified in the “Atlantic Coast market.” In an aspect, the second portion may be associated with any number of classifications. As an example, if the second portion selected is associated with a classification or genus 124 of “East Division” and a sub-classification of “peak time of day” and sub-sub-classification or species of “bandwidth usage over a threshold value”, the resultant information signal or control signal can be transmitted to all devices classified in the “East division” and sub-classified by “bandwidth usage over a threshold value” during “peak time of day.” Accordingly, information signals and /or control signals can be transmitted to select devices based upon classification. Further, the information and/or control signals can be transmitted to various classifications and sub-classifications of devices in response to a single “touch” or “click” of the user interface 106.

In an aspect, each portion of the user interface 106 can represent user selectable options relating to content providers (e.g., Internet service, television service, telephone service, mobile service, etc.) travel packages, e-commerce, group or club memberships, and other tiered structure options and/or packages. Other options and resources can be associated with any portion of the user interface 106.

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

It will be apparent to those skilled in the art that various modifications and variations can be made without departing from the scope or spirit. Other embodiments will be apparent to those skilled in the art from consideration of the specification and practice disclosed herein. It is intended that the specification and examples be considered as exemplary only, with a true scope and spirit being indicated by the following claims.

What is claimed is:

1. A method for interfacing with a user comprising:
classifying each of a plurality of devices based upon one or more of a plurality of genera and a plurality of species relating to characteristics of a respective one of the plurality of devices, wherein each of the plurality of species is subordinate to one or more of the genera;
associating each of a plurality of first portions of an image with one of the plurality of genera;
associating each of a plurality of second portions of the image with one of the plurality of genera and one of the plurality of species;
receiving a selection of one of the plurality of second portions; and
rendering feedback in response to the selection, wherein the feedback is based upon a relationship between the selected second portion and an associated genus and species.

2. The method of claim 1, wherein one or more of the plurality of devices is a communications device.

3. The method of claim 1, wherein each of the plurality of genera is one of a location classifier and a time classifier.

4. The method of claim 3, wherein each of the plurality of species is one of a location sub-classifier and a time sub-classifier.

5. The method of claim 1, wherein each of the plurality of species is a use classifier for a single one of the plurality of devices.

6. The method of claim 1, wherein each of the plurality of species is an aggregate use classifier for a subset of the plurality of devices.

7. The method of claim 1, wherein one or more of the plurality of second portions of the image is disposed radially inward relative to one or more of the plurality of first portions of the image.

8. The method of claim 1, further comprising requesting a resource associated with one or more of the plurality of genera and species in response to receiving a selection of one of the plurality of first portions and second portions

9. A method for interfacing with a user comprising:
classifying each of a plurality of devices based upon one or more of a plurality of genera and a plurality of species relating to characteristics of a respective one of the plurality of devices, wherein each of the plurality of species is subordinate to one or more of the genera;
associating each of a plurality of first portions of an image with one of the plurality of genera;
associating each of a plurality of second portions of the image with one of the plurality of genera and one of the plurality of species;
receiving a selection of one of the plurality of second portions; and
retrieving information related to each of the plurality of devices associated with the selected one of the plurality of second portions.

10. The method of claim 9, wherein one or more of the plurality of devices is a communications device.

11. The method of claim 9, wherein each of the plurality of genera is one of a location classifier and a time classifier.

12. The method of claim 11, wherein each of the plurality of species is one of a location sub-classifier and a time sub-classifier.

13. The method of claim 9, wherein each of the plurality of species is a use classifier for a single one of the plurality of devices.

14. The method of claim 9, wherein each of the plurality of species is an aggregate use classifier for a subset of the plurality of devices.

15. The method of claim 9, wherein one or more of the plurality of second portions of the image is disposed radially inward relative to one or more of the plurality of first portions of the image.

16. A method for interfacing with a user comprising:
classifying each of a plurality of user options based upon one or more of a plurality of genera and a plurality of species relating to preferences of a user, wherein each of the plurality of species is subordinate to one or more of the genera;
associating each of a plurality of first portions of an image with one of the plurality of genera;
associating each of a plurality of second portions of the image with one of the plurality of genera and one of the plurality of species;
receiving a selection of one of the plurality of second portions; and
retrieving information related to each of the plurality of user options associated with the selected one of the plurality of second portions.

17. The method of claim 16, further comprising rendering a feedback in response to the selected one of the plurality of first portions or second portions, wherein the feedback is based upon one or more of the plurality of genera and the plurality of species of a respective one of the plurality of user options associated with the selected one of the plurality of first portions or second portions.

18. The method of claim 16, wherein one or more of the plurality of user options is related to communications service.

19. The method of claim 16, wherein each of the plurality of genera is associated with a particular service identifier.

20. The method of claim 19, wherein each of the plurality of species is associated with a service level of an ascendant one of the service identifiers.

21. The method of claim 16, wherein one or more of the plurality of second portions of the image is disposed radially inward relative to one or more of the plurality of first portions of the image.
